(19) United States
(12) Patent Application Publication
(10) Pub. No.: US 2025/0354736 A1
(43) Pub. Date: Nov. 20, 2025

(54) MULTIPLE FLUID DISTRIBUTION AND REFRIGERATION SYSTEM

(71) Applicant: Siesta Hospitality Group LLC, Sarasota, FL (US)

(72) Inventors: Matthew Henry Grover, Sarasota, FL (US); Troy Doss Syprett, Sarasota, FL (US); Brett Thomas MacIntyre, Sarasota, FL (US)

(21) Appl. No.: 19/209,997

(22) Filed: May 16, 2025

Related U.S. Application Data
(60) Provisional application No. 63/648,297, filed on May 16, 2024.

(51) Int. Cl. F25B 49/02; F25B 41/40

(52) U.S. Cl. CPC F25B 49/02; F25B 41/40

(57) ABSTRACT

A multiple fluid distribution and refrigeration system and method associated therewith are disclosed. The system is configured to transmit large quantities of multiple fluids to various predetermined locations while maintaining a temperature and quality thereof. The system comprises a fluid distribution subsystem configured to distribute a plurality of fluids, a refrigeration subsystem in thermal exchange relationship with the fluid distribution subsystem; and a control subsystem in communication with the fluid distribution subsystem and the refrigeration subsystem

### CROSS-REFERENCE TO RELATED APPLICATION

This application claims the benefit of U.S. Provisional Patent Application Ser. No. 63/648,297, filed May 16, 2024, the entirety of which is herein incorporated by reference.

### FIELD

The disclosure relates to a fluid distribution and refrigeration systems, and more particularly to a multiple fluid distribution and refrigeration system.

### BACKGROUND

Currently, commercial facilities providing food and drink to a large body of people, for example, sports arenas and stadiums, music venues, student unions, shopping centers, resorts, waterparks, restaurants and like, employ the use of individual frozen beverage dispensers. Such dispensers include slushy or granita machines. Typically, conventional granita machines comprise a bowl or tank, where a frozen mixture is stored, an auger that pushes or pulls the frozen mixture inside the bowl, a self-contained refrigeration system to maintain a temperature of the frozen mixture within the bowl, and one or more nozzles or spigots to dispense the frozen mixture from the granita machine.

Proper mixing of the ingredients of the frozen mixture is essential to produce a quality final product. Typically, each of the ingredients is poured into the bowl of the dispenser by the employees of the commercial facilities. In certain instances, the employees may not add the proper quantities of the ingredients, resulting in unpredictable taste, texture, and consistency from one batch of the frozen mixture to another, which may adversely impact customer satisfaction.

Additionally, routine maintenance on the individual dispensers located throughout the commercial facilities require significant time and expense. Small malfunctions may lead to significant repairs if not properly addressed. Oftentimes, employees of the commercial facilities ignore maintenance issues with the dispensers and cease operations of problematic dispensers instead of conducting necessary repairs. This too may negatively affect customer satisfaction and profits of the commercial facilities.

Accordingly, there is a need for a multiple fluid distribution and refrigeration system, which is configured to transmit large quantities of multiple fluids to various predetermined locations while maintaining a temperature and quality thereof.

### SUMMARY

In concordance and agreement with the presently described subject matter, a multiple fluid distribution and refrigeration system, which is configured to transmit large quantities of multiple fluids to various predetermined locations while maintaining a temperature and quality thereof, has surprisingly been designed.

In one embodiment, a multiple fluid distribution and refrigeration system comprises: a fluid distribution subsystem disposed in a facility, wherein the fluid distribution subsystem includes one or more fluid sources fluidly connected to one or more fluid dispensers, wherein the one or more fluid dispensers is disposed in one or more remote locations throughout the facility, and wherein the one or more fluid sources contains a plurality of fluids; a refrigeration subsystem in thermal exchange relationship with the fluid distribution subsystem; and a control subsystem in communication with the fluid distribution subsystem and the refrigeration subsystem.

In another embodiment, a method of distributing and refrigerating multiple fluids, comprises: providing a multiple fluid distribution and refrigeration system including: a fluid distribution subsystem disposed in a facility, wherein the fluid distribution subsystem includes one or more fluid sources fluidly connected to one or more fluid dispensers, wherein the one or more fluid dispensers is disposed in one or more remote locations throughout the facility, and wherein the one or more fluid sources contain a plurality of fluids; a refrigeration subsystem in thermal exchange relationship with the fluid distribution subsystem; and a control subsystem in communication with the fluid distribution subsystem and the refrigeration subsystem; and distributing the fluids from the one or more fluid sources to the one or more fluid dispensers.

As aspects of some embodiments, the one or more fluid sources includes at least one bulk storage tank and/or at least one mixing tank for containing at least one of the fluids therein.

As aspects of some embodiments, the one or more fluid sources is stationary or portable.

As aspects of some embodiments, the one or more fluid dispensers are located within or up to a 500 feet radius from the one or more fluid sources.

As aspects of some embodiments, the fluid distribution subsystem includes one or more fluid manifold assemblies, and wherein the one or more fluid manifold assemblies fluidly connect the one or more fluid sources and the one or more fluid dispensers.

As aspects of some embodiments, each of the fluid manifold assemblies comprises one or more coolant supply conduits of the refrigeration subsystem and/or one or more coolant return conduits of the refrigeration subsystem.

As aspects of some embodiments, each of the fluid manifold assemblies comprises a plurality of conduits for receiving at least one of the fluids therethrough.

As aspects of some embodiments, each of the fluid manifold assemblies further comprises heat shrink tubing and/or a layer of insulation surrounding the conduits.

As aspects of some embodiments, at least one of the conduits has a glass-flex coated interior and/or is flushable for sanitation purposes.

As aspects of some embodiments, each of the fluid manifold assemblies comprises a main line and one or more secondary lines.

As aspects of some embodiments, the main line includes the conduits for each of the fluids and each of the secondary lines includes the conduits for a certain number of the fluids.

As aspects of some embodiments, the main line includes sixteen of the conduits for each of the fluids and four of the secondary lines each includes four of the conduits for the fluids.

As aspects of some embodiments, the fluids in the fluid distribution subsystem are in thermal energy exchange relationship with a coolant in the refrigeration subsystem.

As aspects of some embodiments, one or more of the fluid dispensers is fluidly connected to a source of inert gas.

As aspects of some embodiments, each of the fluids is different from another one of the fluids.

As aspects of some embodiments, a temperature of each of the fluids is at or below 39 degrees Fahrenheit.

As aspects of some embodiments, the fluid distribution subsystem further includes a control assembly in communication with at least one of the one or more fluid sources, and wherein the control assembly selectively controls a flow of the fluid in the one or more fluid sources.

As aspects of some embodiments, the control subsystem includes a controller in communication with the fluid distribution subsystem and the refrigeration subsystem to selectively controls a flow of the fluids through the fluid distribution subsystem and a flow of the coolant through the refrigeration subsystem.

As aspects of some embodiments, at least one of the fluid distribution subsystem and the refrigeration subsystem further includes one or more sensors in communication with the controller of the control subsystem.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram of a multiple fluid distribution and refrigeration system according to an embodiment of the present disclosure, wherein the multiple fluid distribution and refrigeration system includes a fluid distribution subsystem, a refrigeration subsystem, and a control subsystem;

FIG. 2 is a schematic cross-sectional view of a main line of the fluid distribution subsystem of FIG. 1, wherein the main line comprises sixteen fluid conduits and supply and return conduits of the refrigeration subsystem;

FIG. 3 is a schematic cross-sectional view of a secondary line of the fluid distribution subsystem of FIG. 1, wherein the secondary line comprises four fluid conduits and supply and return conduits of the refrigeration subsystem; and

FIG. 4 is a schematic view of a fluid dispenser of the fluid distribution subsystem of FIG. 1.

### DETAILED DESCRIPTION

The following description of technology is merely exemplary in nature of the subject matter, manufacture and use of one or more present disclosures, and is not intended to limit the scope, application, or uses of any specific present disclosure claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

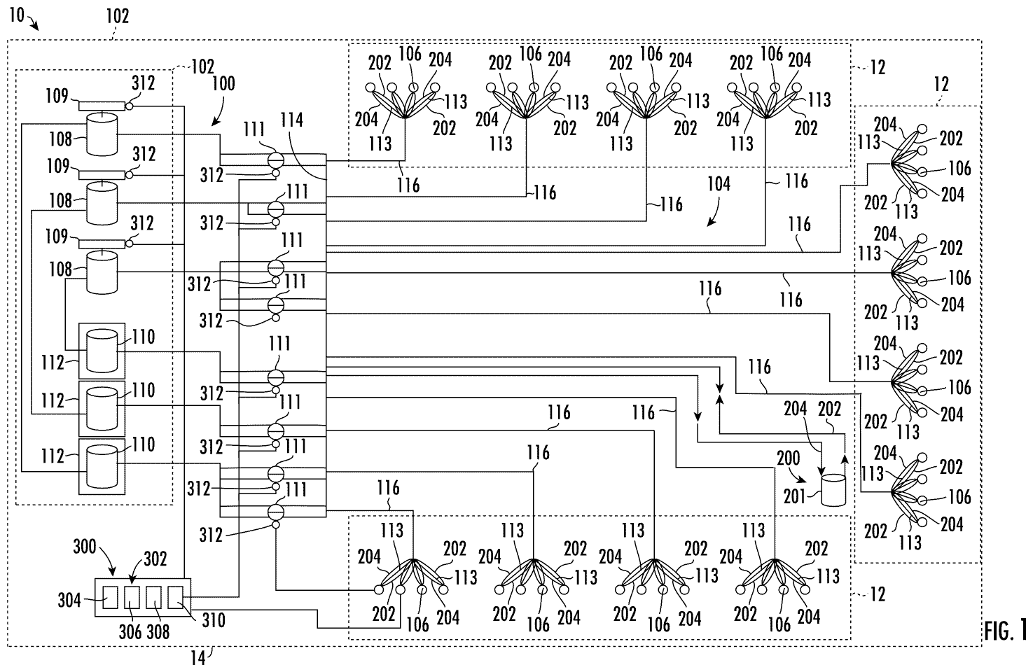

FIG. 1 shows a multiple fluid distribution and refrigeration system 10 in accordance with an embodiment of the present disclosure. The system 10 comprises a fluid distribution subsystem 100 for a plurality of fluids, a refrigeration subsystem 200 providing a coolant source 201, and a control subsystem 300 in communication with the fluid distribution subsystem 100 and the refrigeration subsystem 200. Each of the subsystems 100, 200, 300 may have components of the other subsystems 100, 200, 300 integrated therein as described hereinafter. Advantageously, the system 10 is designed to maintain a temperature and quality of the fluids being distributed. Although the system 10 shown is configured to provide the fluids to numerous locations 12 (e.g., concessions areas) within a commercial facility 14 (e.g., sports arenas and stadiums, music venues, student unions, shopping centers, resorts, waterparks, restaurants and like), it is understood that the system 10 may be used to distribute other types of fluids in various applications.

Referring now to the fluid distribution subsystem 100 shown in FIG. 1 having parts of the refrigeration subsystem 200 and the control subsystem 300 integrated therein. In some embodiments, the fluid distribution subsystem 100 comprises one or more fluid sources 102, one or more fluid manifold assemblies 104, and network of fluid dispensers 106. Any number of the fluid sources 102, the fluid manifold assemblies 104, and the fluid dispensers 106 may be employed in the fluid distribution subsystem 100 as desired. The fluid sources 102 may be stationary in a fixed location or portable to various locations with the facility 14. The fluid sources 102 may comprise one or more bulk storage tanks 108 (e.g., 100 gallon plastic tank, 50 gallon plastic tank, etc.), for example. Each of the bulk storage tanks 108 may be configured to hold at least one ingredient of the fluids or one of the fluids to be distributed. A control assembly 109 may be coupled to each of the bulk storage tanks 108. The control assembly 109 may include fluid pumps and valves (e.g., main drain valves) to selectively control a flow of the fluids for circulation, filling, and emptying of the bulk storage tanks 108.

In certain embodiments, the fluid sources 102 may further include one or more mixing tanks 110 (e.g., a stainless steel tank) configured to receive one or more of the ingredients needed to produce the fluids to be distributed. Various components, for example, pumps, valves, sensors, gauges, ports, and other plumbing, may be fluidly and/or electrically connected to the bulk storage tanks 108 and/or the mixing tanks 110 to facilitate circulation, filling, draining, and maintenance thereof. As a non-limiting example, at least one of the bulk storage tanks 108 and/or at least one of the mixing tanks 110 may include at least one sensor to detect a fluid level therein, an inlet port for stirring and agitation of the fluids, and/or an outlet port for fluid communication with at least one control assembly 111. The least one control assembly 111 may be fluidly connected to one or more of the bulk storage tanks 108 and/or one or more of the mixing tanks 110. The at least one control assembly 111 may include fluid pumps and valves to selectively control a flow of the fluids for circulation and filling of the fluid manifold assemblies 104.

In some embodiments, one or more of the bulk storage tanks 108 and/or one or more of the mixing tanks 110 may be arranged together at a single location or separate locations, as depicted in FIG. 1. It is understood, however, that other arrangements and number of the bulk storage tanks 108 and/or the mixing tanks 110 may be utilized at various locations throughout the facility 14 if desired. As shown, one or more of the mixing tanks 110 may be coupled to a material handling device 112 for transport throughout the facility 14.

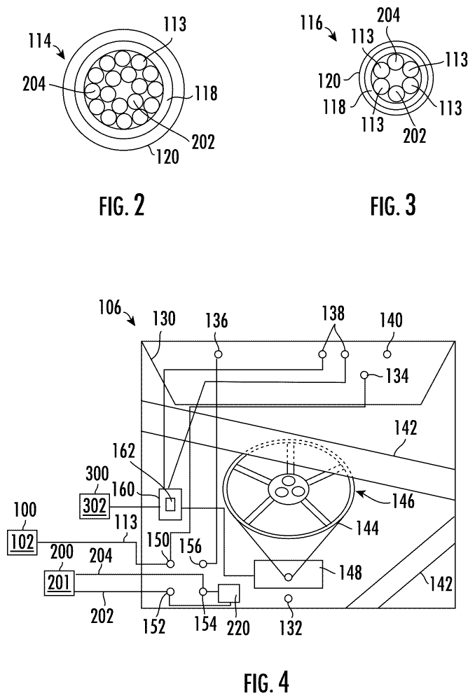

An exemplary one of the fluid manifold assemblies 104 in accordance with an embodiment of the present disclosure is illustrated in FIG. 1. Each of the fluid manifold assemblies 104 comprises a plurality of conduits 113 and various other plumbing components such as fittings, clamps, and the like, for example. In some embodiments, the plumbing components may be aerospace grade and/or produced from a durable material such as a stainless steel, for example. The fluid manifold assemblies 104 fluidly connect the fluid sources 102 to the network of fluid dispensers 106. In some embodiments, the fluid manifold assemblies 104 may be configured to supply the fluids from the fluid sources 102 to the substantially remote fluid dispensers 106. For example, the fluid dispensers 106 may be located within or up to 500 feet away from the fluid sources 102. In certain embodiments, the fluid manifold assemblies 104 may be antimicrobial and specifically designed for use with beverage products kept at cold temperatures. The conduits 113 may have glass-flex coated interiors and flushable for sanitation purposes. The fluid manifold assemblies 104 of the present disclosure are capable of achieving high-volume, high-quality fluid distribution, while maintaining temperature control of the fluids. In some embodiments, the fluid manifold assemblies 104 are capable of maintaining the temperature of the fluids at or below a desired temperature threshold, for example, about 39° Fahrenheit. In certain embodiments, the temperature of the fluids is maintained at or below the desired temperature threshold as the fluids are distributed from the one or more fluid sources 102, through the one or more fluid manifold assemblies 104, to each of the fluid dispensers 106. Each of the fluid manifold assemblies 104 may comprise a main line 114 and one or more secondary lines 116 branching from the main line 114. The main line 114 includes the conduits 113 for each of the fluids and each of the secondary lines 116 may only include a certain number of the conduits 113 for a specific number of the fluids bundled together. For example, one of the fluid manifold assemblies 104 for a sixteen-fluid system may comprise a main line 114 including sixteen conduits 113 for all sixteen fluids, as depicted in FIG. 2, and four secondary lines 116, each of which includes a bundle of four of the conduits 113, as depicted in FIG. 3, each of the conduits 113 associated with one of the fluids to be distributed.

In some embodiments, the fluid manifold assemblies 104 may further include one or more supply conduits 202 for a coolant (e.g., glycol) leading from the coolant source 201 to the fluid dispensers 106 and/or one or more return conduits 204 leading from the fluid dispensers 106 to the coolant source 201 of the refrigeration subsystem 200 disposed therein. The coolant supply and return conduits 202, 204 may be disposed in the main line 114 and/or the secondary lines 116 of the fluid manifold assemblies 104 to further maintain the temperature of the fluids flowing therethrough to the network of fluid dispensers 106. The fluids in the conduits 113 are in thermal exchange relationship with the coolant in the supply and return conduits 202, 204. More particularly, the coolant in the supply and return conduits 202, 204 absorbs heat from the fluid in the conduits 202, 204 to achieve and/or maintain the desired temperature of the fluids. The fluid manifold assemblies 104 provide air-tight insulating and leak-free connections between the conduits 113 and the other plumbing components. Heat-shrink tubing 118 and double-thickness insulation 120 may be employed to enhance thermal performance and provide for easier cleaning of the fluid manifold assemblies 104.

FIG. 4 shows an exemplary schematic fluid dispenser of the network of fluid dispensers 106 in accordance with an embodiment of the present disclosure. In some embodiments, the fluid dispenser 106 comprises a hopper or tank 130, where one of the fluids in a relatively low-temperature state (i.e., semi-solid, semi-frozen) is stored, an auger that agitates the relatively low-temperature fluid inside the hopper 130, a self-contained refrigeration system 146 to maintain a temperature of the relatively low-temperature fluid within the hopper 130, and one or more nozzles or spigots 132 to dispense the relatively low-temperature fluid from the fluid dispenser 106. In some embodiments, the hopper 130 may include a fluid inlet port 134, an inert gas inlet port 136 (e.g., a nitrogen gas port) for blanketing of tank or hopper 130 (freshness preservation), one or more fluid level sensors 138, and/or an overfill switch 140. The fluid inlet port 134 may be fluidly connected to one of the conduits 113 of the fluid manifold assemblies 104 to permit a flow of one of the fluids from the fluid source 102 into the hopper 130. Each of the sensors 138 and/or the switch 140 may be in electrical communication with the control subsystem 300 to facilitate control of the temperature and amount of the fluid within the hopper 130. At least one guard 142 may be included in the fluid dispenser 106 to protect other components from a driving belt 144 of the self-container refrigeration system 146 thereof. As depicted the driving belt 144 is driven by an electric motor 148 of the self-contained refrigeration system 146. A fluid supply port 150, coolant inlet and outlet ports 152, 154 to support fluid temperature management, and an inert gas inlet 156 may be installed in and provided with the fluid dispenser 106. The fluid inlet port 150 may be fluidly connected to one of the conduits 113 of the fluid manifold assemblies 104 to permit a flow of the temperature-controlled fluid from the fluid sources 102 (i.e., bulk storage tanks) through the fluid manifold assemblies 104 to the fluid dispensers 106. The coolant inlet and outlet ports 152, 154 may be fluidly connected to the supply and return conduits 202, 204 of the refrigeration subsystem 200 that provides cooling to the fluid dispenser 106 itself in the event a “remote condenser” dispenser unit is chosen.

As shown, an electrical control unit 160 including various electrical components 162 of the fluid dispenser 106 may be located with an interior thereof to increase a longevity and serviceability. For instance, sensitive components may be located to areas less prone to condensation and other components, like controls and valves, that may require more frequent maintenance may be located in more accessible areas of the fluid dispenser 106. Interlock and fill system relays may be integrated into the fluid dispenser 106 for communication with a remote filling system, via the control subsystem 300. A higher R-value insulation and seamless shrink tubing may be employed with the self-contained refrigeration system 146 in the fluid dispenser 106 to increase thermal performance and ease of maintenance.

It is understood that the fluid distribution subsystem 100 may require more or less components than shown in FIGS. 1 and 4 necessary for operation of the multiple fluid distribution and refrigeration system.

Referring back to FIG. 1, an exemplary refrigeration subsystem 200 in accordance with an embodiment of the present disclosure is illustrated. In some embodiments, the refrigeration subsystem 200 may comprise the coolant source 201, the supply and return conduits 202, 204, and various other plumbing components such as fittings, valves, and the like, for example. The coolant within the refrigeration subsystem 200 provides cooling to the fluids in the fluid manifold assemblies 104 and/or the relatively low-temperature fluid in the fluid dispensers 106 of the fluid distribution subsystem 100. The supply and return conduits 202, 204 each may be configured to increase a surface area thereof to increase the thermal energy exchange between the fluids in the fluid distribution subsystem 100 and the coolant in the refrigeration subsystem 200. One or more of the supply and return conduits 202, 204 of the refrigeration subsystem 200 located within the fluid dispensers 106 may be covered with an insulating material to minimize a thermal energy exchange of the coolant with the surrounding components of the fluid dispensers 106.

It is understood that the refrigeration subsystem 200 may require more or less components than shown in FIGS. 1 and 4 necessary for operation of the multiple fluid distribution and refrigeration system 10.

FIGS. 1 and 4 show an exemplary control subsystem 300 in accordance with an embodiment of the present disclosure. The control subsystem 300, shown in FIG. 1, may include various components 302, for example, at least one user interface 304, at least one processor 306 in communication with at least one memory device 308 having executable instructions, at least one application 310, and at least sensor 312 configured to monitor and/or track various parameters of the multiple fluid distribution and refrigeration system 10. It is understood that the control subsystem 300 may require more or less components than shown in FIGS. 1 and 4 necessary for operation of the multiple fluid distribution and refrigeration system 10.

In some embodiments, the at least one application 310 may receive data from various sensors (including the sensors 138, 312) and share data with the at least one processor 306 and/or a cloud storage service. In some examples, the at least one application 310 may be accessed via the at least one user interface 304 or other computing device and data may be manually input. For instance, a user may input a desired formula of ingredients, fluid temperature settings, maintenance information, etc.

The control subsystem 300 may include multiple processing and memory resources. In such examples, the instructions may be distributed (e.g., stored) across multiple memory devices 308 and the instructions may be distributed (e.g., executed by) across multiple processors 306. The at least one memory device 308 may be an electronic, magnetic, optical, or other physical storage device that stores executable instructions. Thus, the at least one memory device 308 may be, for example, non-volatile or volatile memory. For example, non-volatile memory can provide persistent data by retaining written data when not powered, and non-volatile memory types can include NAND flash memory, NOR flash memory, read only memory (ROM), Electrically Erasable Programmable ROM (EEPROM), Erasable Programmable ROM (EPROM), and Storage Class Memory (SCM) that can include resistance variable memory, such as phase change random access memory (PCRAM), three-dimensional cross-point memory, resistive random access memory (RRAM), ferroelectric random access memory (FeRAM), magnetoresistive random access memory (MRAM), and programmable conductive memory, among other types of memory. Volatile memory can require power to maintain its data and can include random-access memory (RAM), dynamic random-access memory (DRAM), and static random-access memory (SRAM), among others.

In some embodiments, the at least one memory device 308 is a non-transitory MRM comprising Random Access Memory (RAM), an Electrically-Erasable Programmable ROM (EEPROM), a storage drive, an optical disc, and the like. The at least one memory device 308 may be disposed within a controller and/or computing device. In this example, the executable instructions can be “installed” on the device. Additionally, and/or alternatively, the at least one memory device 308 can be a portable, external or remote storage medium, for example, that allows the multiple fluid distribution and refrigeration system 10 to download the instructions from the portable/external/remote storage medium. In this situation, the executable instructions may be part of an “installation package”. As described herein, the at least one memory device 308 can be encoded with executable instructions for distribution and refrigeration of the fluids.

The instructions, when executed by the at least one processor 306, may include instructions to receive signals from the various sensors (including sensors 138, 312) configured to monitor parameters of the multiple fluid distribution and refrigeration system 10, for example, the sensors 138 located within the hopper 130 of the fluid dispensers 106. Further, the instructions, when executed by the at least one processor 306, may include instructions to transmit output data representative of abnormal operations. For instance, if the sensors (including sensors 138, 312) detect a drop in the fluid level below a lower threshold, the output data can include an alert to the multiple fluid distribution and refrigeration system 10 and/or a user of the multiple fluid distribution and refrigeration system 10 indicating assistance may be needed. Such other non-limiting examples include monitoring supply levels of the fluids located in the tanks 108, 110 of the fluid sources 102, providing agitation to keep soft solids (e.g., pulp, seeds, fruit fibers, etc.) and sugars from settling out of the mixed fluids, indicating low supply, low air pressure, call for fill from the fluid dispensers 106, overfill conditions, and agitation status of the tanks 108, 110.

The control subsystem 300 may be in communication with other devices and components, including but not limited to the fluid distribution subsystem 100 and the refrigeration subsystem 200, computing devices, a cloud storage service, or any combination thereof to work together to appropriately distribute, refrigerate, and dispense the fluids. The control subsystem 300 may also serve as an interlock safety system to isolate and cease operations of certain fluid dispensers 106 if an overfill condition or other maintenance issue arises.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A multiple fluid distribution and refrigeration system comprising:
a fluid distribution subsystem disposed in a facility, wherein the fluid distribution subsystem includes one or more fluid sources fluidly connected to one or more fluid dispensers, wherein the one or more fluid dispensers is disposed in one or more remote locations throughout the facility, and wherein the one or more fluid sources contains a plurality of fluids;
a refrigeration subsystem in thermal exchange relationship with the fluid distribution subsystem; and
a control subsystem in communication with the fluid distribution subsystem and the refrigeration subsystem.

2. The system of claim 1, wherein the one or more fluid sources includes at least one bulk storage tank and/or at least one mixing tank for containing at least one of the fluids therein.

3. The system of claim 1, wherein the one or more fluid sources is stationary or portable.

4. The system of claim 1, wherein the one or more fluid dispensers are located within or up to a 500 feet radius from the one or more fluid sources.

5. The system of claim 1, wherein the fluid distribution subsystem includes one or more fluid manifold assemblies, and wherein the one or more fluid manifold assemblies fluidly connect the one or more fluid sources and the one or more fluid dispensers.

6. The system of claim 5, wherein each of the fluid manifold assemblies comprises one or more coolant supply conduits of the refrigeration subsystem and/or one or more coolant return conduits of the refrigeration subsystem.

7. The system of claim 5, wherein each of the fluid manifold assemblies comprises a plurality of conduits for receiving at least one of the fluids therethrough.

8. The system of claim 7, wherein each of the fluid manifold assemblies further comprises heat shrink tubing and/or a layer of insulation surrounding the conduits.

9. The system of claim 7, wherein at least one of the conduits has a glass-flex coated interior and/or is flushable for sanitation purposes.

10. The system of claim 7, wherein each of the fluid manifold assemblies comprises a main line and one or more secondary lines.

11. The system of claim 10, wherein the main line includes the conduits for each of the fluids and each of the secondary lines includes the conduits for a certain number of the fluids.

12. The system of claim 10, wherein the main line includes sixteen of the conduits for each of the fluids and four of the secondary lines each includes four of the conduits for the fluids.

13. The system of claim 1, wherein the fluids in the fluid distribution subsystem are in thermal energy exchange relationship with a coolant in the refrigeration subsystem.

14. The system of claim 1, wherein one or more of the fluid dispensers is fluidly connected to a source of inert gas.

15. The system of claim 1, wherein each of the fluids is different from another one of the fluids.

16. The system of claim 1, wherein a temperature of each of the fluids is at or below 39 degrees Fahrenheit.

17. The system of claim 1, wherein the fluid distribution subsystem further includes a control assembly in communication with at least one of the one or more fluid sources, and wherein the control assembly selectively controls a flow of the fluid in the one or more fluid sources.

18. The system of claim 1, wherein the control subsystem includes a controller in communication with the fluid distribution subsystem and the refrigeration subsystem to selectively controls a flow of the fluids through the fluid distribution subsystem and a flow of the coolant through the refrigeration subsystem.

19. The system of claim 18, wherein at least one of the fluid distribution subsystem and the refrigeration subsystem further includes one or more sensors in communication with the controller of the control subsystem.

20. A method of distributing and refrigerating multiple fluids, comprising:
providing a multiple fluid distribution and refrigeration system including:
a fluid distribution subsystem disposed in a facility, wherein the fluid distribution subsystem includes one or more fluid sources fluidly connected to one or more fluid dispensers, wherein the one or more fluid dispensers is disposed in one or more remote locations throughout the facility, and wherein the one or more fluid sources contain a plurality of fluids;
a refrigeration subsystem in thermal exchange relationship with the fluid distribution subsystem; and
a control subsystem in communication with the fluid distribution subsystem and the refrigeration subsystem; and
distributing the fluids from the one or more fluid sources to the one or more fluid dispensers.
